(19) United States
(12) Patent Application Publication
(10) Pub. No.: US 2017/0041984 A1
(43) Pub. Date: Feb. 9, 2017

(54) TECHNIQUES FOR RETRANSMITTING PHYSICAL LAYER PACKETS AFTER INACTIVITY ON A SECONDARY COMPONENT CARRIER

(71) Applicant: QUALCOMM Incorporated, San Diego, CA (US)

(72) Inventors: Ambuj Agrawal, San Diego, CA (US); Mohammed Al Khairy, San Diego, CA (US); Shailesh Maheshwari, San Diego, CA (US); Gang Andy Xiao, San Diego, CA (US); Aziz Gholmieh, Del Mar, CA (US); Heechoon Lee, San Diego, CA (US); Sarabjot Singh Khangura, San Diego, CA (US); Feilu Liu, San Diego, CA (US)

(21) Appl. No.: 15/197,264

(22) Filed: Jun. 29, 2016

Related U.S. Application Data
(60) Provisional application No. 62/201,043, filed on Aug. 4, 2015.

(51) Int. Cl. H04W 76/06; H04L 12/801; H04W 72/04

(52) U.S. Cl. CPC H04W 76/068; H04W 72/0453; H04L 47/34

(57) ABSTRACT

Techniques are described for wireless communication. One method includes identifying a decoding status of one or more physical layer packets before inactivity on a secondary component carrier (SCC) in a shared radio frequency spectrum band; initiating an SCC reordering timer, wherein the SCC reordering timer is initiated when the decoding status of the one or more physical layer packets is identified as unsuccessful; and triggering a transmission, to a base station, of a radio link control (RLC) status report upon expiration of the SCC reordering timer. The RLC status report is transmitted before expiration of a RLC reordering timer initiated when the decoding status of the one or more physical layer packets is identified as unsuccessful. In some examples, the method may include resetting the SCC reordering timer when one or more additional physical layer packets are received on the SCC.

### CROSS REFERENCES

The present application for patent claims priority to U.S. Provisional Patent Application No. 62/201,043 by Agrawal et al., entitled “Techniques For Retransmitting Radio Link Control Packets After A Deactivation Of A Secondary Component Carrier,” filed Aug. 4, 2015, assigned to the assignee hereof, which is hereby incorporated by reference in its entirety.

### BACKGROUND

Field of the Disclosure

The present disclosure, for example, relates to wireless communication systems, and more particularly to techniques for retransmitting physical layer packets after inactivity on a secondary component carrier (SCC) in a shared radio frequency spectrum band.

Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipments (UEs). A base station may communicate with UEs on downlink channels (e.g., for transmissions from a base station to a UE) and uplink channels (e.g., for transmissions from a UE to a base station).

Some modes of communication may enable communication between a base station and a UE in a shared radio frequency spectrum band, or in different radio frequency spectrum bands (e.g., in a dedicated radio frequency spectrum band and a shared radio frequency spectrum band) of a cellular network. However, in contrast to a dedicated radio frequency spectrum band, which may be allocated for use by the devices of one public land mobile network (PLMN) and be available to a base station of the PLMN at predetermined (or all) times, a shared radio frequency spectrum band may be available for use by the devices of a PLMN intermittently. This intermittent availability may be a result of contention for access to the shared radio frequency spectrum band by devices of the PLMN, by devices of one or more other PLMNs, and/or by other devices (e.g., Wi-Fi devices).

### SUMMARY

The present disclosure, for example, relates to wireless communication systems, and more particularly to techniques for retransmitting physical layer packets after inactivity on a secondary component carrier (SCC) in a shared radio frequency spectrum band. When a base station communicates with a user equipment (UE) on an SCC in a shared radio frequency spectrum band, inactivity on the SCC may occur as a result of losing contention for access to the shared radio frequency spectrum band. Under some conditions, SCC inactivity may occur frequently, and may interfere with packet retransmission processes on the SCC. At times, packet retransmission following inactivity on an SCC may not occur until a radio link control (RLC) reordering timer expires. However, the RLC reordering timer may have a relatively long duration, and given that it is known that physical layer packet retransmission may not occur on the SCC before the RLC reordering timer expires (e.g., because the SCC is not active), it may be desirable to trigger a retransmission of unsuccessfully decoded physical layer packets received on the SCC at an earlier time.

A method of wireless communication is described. The method may include identifying a decoding status of one or more physical layer packets before inactivity on a SCC in a shared radio frequency spectrum band, initiating an SCC reordering timer, the SCC reordering timer initiated when the decoding status of the one or more physical layer packets is identified as unsuccessful, and triggering a transmission, to a base station, of an RLC status report upon expiration of the SCC reordering timer, the RLC status report transmitted before expiration of an RLC reordering timer initiated when the decoding status of the one or more physical layer packets is identified as unsuccessful.

An apparatus for wireless communication is described. The apparatus may include means for identifying a decoding status of one or more physical layer packets before inactivity on an SCC in a shared radio frequency spectrum band, initiating an SCC reordering timer, the SCC reordering timer initiated when the decoding status of the one or more physical layer packets is identified as unsuccessful, and triggering a transmission, to a base station, of an RLC status report upon expiration of the SCC reordering timer, the RLC status report transmitted before expiration of an RLC reordering timer initiated when the decoding status of the one or more physical layer packets is identified as unsuccessful.

Another apparatus for wireless communication is described. The apparatus may include a processor, memory in electronic communication with the processor, and instructions stored in the memory. The instructions may be operable to cause the processor to identify a decoding status of one or more physical layer packets before inactivity on an SCC in a shared radio frequency spectrum band, initiate an SCC reordering timer, the SCC reordering timer initiated when the decoding status of the one or more physical layer packets is identified as unsuccessful, and trigger a transmission, to a base station, of an RLC status report upon expiration of the SCC reordering timer, the RLC status report transmitted before expiration of an RLC reordering timer initiated when the decoding status of the one or more physical layer packets is identified as unsuccessful.

A non-transitory computer readable medium for wireless communication is described. The non-transitory computer readable medium ructions operable to cause a processor to identify a decoding status of one or more physical layer packets before inactivity on an SCC in a shared radio frequency spectrum band, initiate an SCC reordering timer, the SCC reordering timer initiated when the decoding status of the one or more physical layer packets is identified as unsuccessful, and trigger a transmission, to a base station, of an RLC status report upon expiration of the SCC reordering timer, the RLC status report transmitted before expiration of an RLC reordering timer initiated when the decoding status of the one or more physical layer packets is identified as unsuccessful.

In some examples of the method, apparatus, and non-transitory computer-readable medium described above, the unsuccessful decoding status is associated with the SCC. Some examples of the method, apparatus, and non-transitory computer-readable medium described above may further include processes, features, means, or instructions for resetting the SCC reordering timer when a physical layer packet is received. Some examples of the method, apparatus, and non-transitory computer-readable medium described above may further include processes, features, means, or instructions for generating the RLC status report upon the expiration of the SCC reordering timer following the inactivity on the SCC.

In some examples of the method, apparatus, and non-transitory computer-readable medium described above, the SCC reordering timer includes a predefined duration or a dynamically configured duration. Some examples of the method, apparatus, and non-transitory computer-readable medium described above may further include processes, features, means, or instructions for communicating with the base station on a primary component carrier (PCC) in a dedicated radio frequency spectrum band before and after the inactivity on the SCC. Some examples of the method, apparatus, and non-transitory computer-readable medium described above may further include processes, features, means, or instructions for stopping and resetting the RLC reordering timer based at least in part on triggering the transmission of the RLC status report. In some examples of the method, apparatus, and non-transitory computer-readable medium described above, the RLC status report includes a status for physical layer packets associated with sequence numbers preceding a sequence number of a first physical layer packet received after the inactivity on the SCC.

A method of wireless communication is described. The method may include transmitting a sequence of physical layer packets to a UE, maintaining a mapping between the sequence of physical layer packets and a physical channel transmitted to the UE on an SCC in a shared radio frequency spectrum band, and retransmitting at least one physical layer packet to the UE based at least in part on determining the SCC is inactive and determining at least one transmission on the physical channel is negatively acknowledged, the at least one transmission on the physical channel corresponding to the at least one physical layer packet.

An apparatus for wireless communication is described. The apparatus may include means for transmitting a sequence of physical layer packets to a UE, maintaining a mapping between the sequence of physical layer packets and a physical channel transmitted to the UE on an SCC in a shared radio frequency spectrum band, and retransmitting at least one physical layer packet to the UE based at least in part on determining the SCC is inactive and determining at least one transmission on the physical channel is negatively acknowledged, the at least one transmission on the physical channel corresponding to the at least one physical layer packet.

Another apparatus for wireless communication is described. The apparatus may include a processor, memory in electronic communication with the processor, and instructions stored in the memory. The instructions may be operable to cause the processor to transmit a sequence of physical layer packets to a UE, maintain a mapping between the sequence of physical layer packets and a physical channel transmitted to the UE on an SCC in a shared radio frequency spectrum band, and retransmit at least one physical layer packet to the UE based at least in part on determining the SCC is inactive and determining at least one transmission on the physical channel is negatively acknowledged, the at least one transmission on the physical channel corresponding to the at least one physical layer packet.

A non-transitory computer readable medium for wireless communication is described. The non-transitory computer readable medium ructions operable to cause a processor to transmit a sequence of physical layer packets to a UE, maintain a mapping between the sequence of physical layer packets and a physical channel transmitted to the UE on an SCC in a shared radio frequency spectrum band, and retransmit at least one physical layer packet to the UE based at least in part on determining the SCC is inactive and determining at least one transmission on the physical channel is negatively acknowledged, the at least one transmission on the physical channel corresponding to the at least one physical layer packet.

In some examples of the method, apparatus, and non-transitory computer-readable medium described above, retransmitting of the at least one physical layer packet occurs on a primary component carrier (PCC) in a dedicated radio frequency spectrum band.

### BRIEF DESCRIPTION OF THE DRAWINGS

A further understanding of the nature and advantages of the present disclosure may be realized by reference to the following drawings. In the appended figures, similar components or functions may have the same reference label. Additionally, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communication system, in accordance with various aspects of the present disclosure;

FIG. 2 shows a wireless communication system in which Long Term Evolution (LTE)/LTE-Advanced (LTE-A) may be deployed under different scenarios using a shared radio frequency spectrum band, in accordance with various aspects of the present disclosure;

FIG. 3 shows a timeline of physical layer packet reception at a user equipment (UE), in accordance with various aspects of the present disclosure;

FIG. 4 shows a timeline of physical layer packet transmission at a base station, in accordance with various aspects of the present disclosure;

FIG. 5 shows a block diagram of an apparatus for use in wireless communication, in accordance with various aspects of the present disclosure;

FIG. 6 shows a block diagram of an apparatus for use in wireless communication, in accordance with various aspects of the present disclosure;

FIG. 7 shows a block diagram of a UE for use in wireless communication, in accordance with various aspects of the present disclosure;

FIG. 8 shows a block diagram of a base station (e.g., a base station forming part or all of an eNodeB (eNB)) for use in wireless communication, in accordance with various aspects of the present disclosure;

FIG. 9 is a flow chart illustrating an example of a method for wireless communication at a UE, in accordance with various aspects of the present disclosure;

FIG. 10 is a flow chart illustrating an example of a method for wireless communication at a UE, in accordance with various aspects of the present disclosure;

FIG. 11 is a flow chart illustrating an example of a method for wireless communication at a UE, in accordance with various aspects of the present disclosure; and

FIG. 12 is a flow chart illustrating an example of a method for wireless communication at a base station, in accordance with various aspects of the present disclosure.

### DETAILED DESCRIPTION

Techniques are described in which a shared radio frequency spectrum band is used for at least a portion of communications over a wireless communication system. In some examples, the shared radio frequency spectrum band may be used for Long Term Evolution (LTE)/LTE-Advanced (LTE-A) communications. The shared radio frequency spectrum band may be used in combination with, or independent from, a dedicated radio frequency spectrum band. The dedicated radio frequency spectrum band may include a radio frequency spectrum band for which transmitting apparatuses may not contend for access (e.g., a radio frequency spectrum band licensed to users for communications, such as a licensed radio frequency spectrum band usable for LTE/LTE-A communications). The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner).

With increasing data traffic in cellular networks that use a dedicated radio frequency spectrum band, offloading of at least some data traffic to a shared radio frequency spectrum band may provide a cellular operator (e.g., an operator of a public land mobile network (PLMN) or a coordinated set of base stations defining a cellular network, such as an LTE/LTE-A network) with opportunities for enhanced data transmission capacity. Use of a shared radio frequency spectrum band may also provide service in areas where access to a dedicated radio frequency spectrum band is unavailable. Before communicating over a shared radio frequency spectrum band, a transmitting apparatus may perform a listen before talk (LBT) procedure to gain access to the shared radio frequency spectrum band. Such an LBT procedure may include performing a clear channel assessment (CCA) procedure (or an extended CCA procedure) to determine whether a channel of the shared radio frequency spectrum band is available. When it is determined that the channel of the shared radio frequency spectrum band is available, a channel reservation signal (e.g., a channel usage beacon signal (CUBS)) may be transmitted to reserve the channel. When it is determined that a channel is not available, a CCA procedure (or extended CCA procedure) may be performed for the channel again at a later time.

Because a device may win or lose contention for access to a channel of a shared radio frequency spectrum band for a given time interval, based on the unknown and possibly random activity of one or more other devices, access to the shared radio frequency spectrum band cannot be guaranteed. The lack of guaranteed access to a shared radio frequency spectrum band can interfere with packet retransmission processes.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

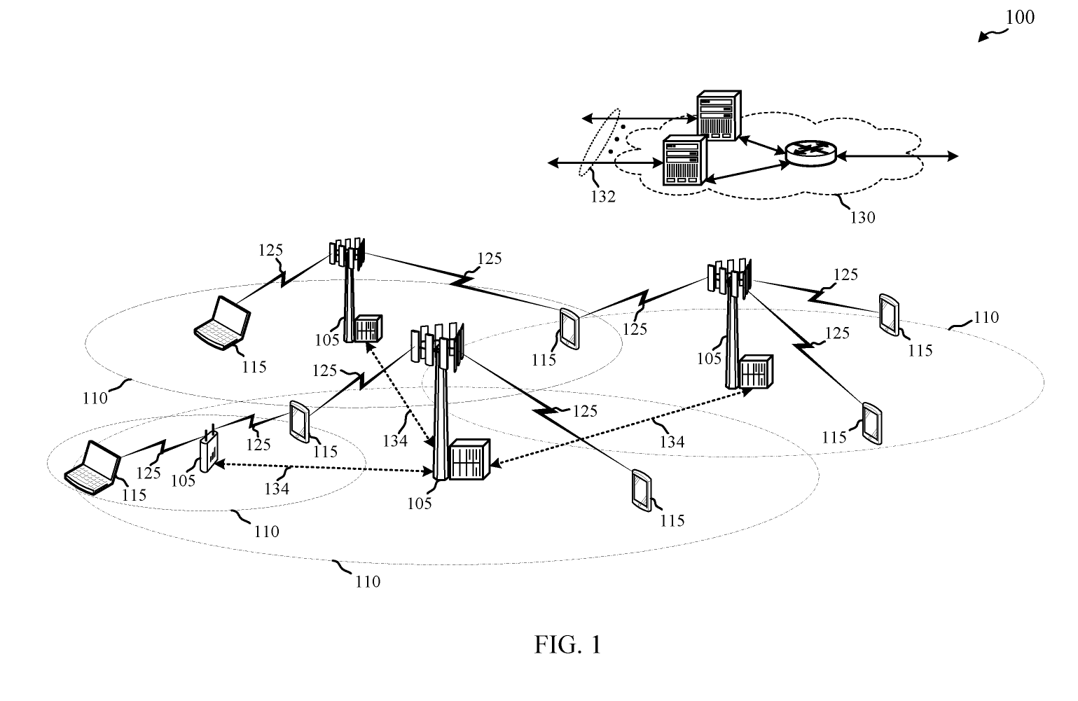

FIG. 1 illustrates an example of a wireless communication system 100, in accordance with various aspects of the present disclosure. The wireless communication system 100 may include base stations 105, user equipment (UEs) 105, and a core network 130. The core network 130 may provide user authentication, access authorization, tracking, Internet Protocol (IP) connectivity, and other access, routing, or mobility functions. The base stations 105 may interface with the core network 130 through backhaul links 132 (e.g., Si, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, a base station 105 may be referred to as a base transceiver station, a radio base station, an access point, a radio transceiver, a NodeB, an eNodeB (eNB), a Home NodeB, a Home eNodeB, or some other suitable terminology. The geographic coverage area 110 for a base station 105 may be divided into sectors making up a portion of the coverage area (not shown). The wireless communication system 100 may include base stations 105 of different types (e.g., macro or small cell base stations). There may be overlapping geographic coverage areas 110 for different technologies.

In some examples, the wireless communication system 100 may include an LTE/LTE-A network. In LTE/LTE-A networks, the term evolved Node B (eNB) may be used to describe the base stations 105, while the term UE may be used to describe the UEs 115. The wireless communication system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a 3rd Generation Partnership Project (3GPP) term that can be used to describe a base station 105, a carrier or component carrier associated with a base station 105, or a coverage area (e.g., sector, etc.) of a carrier or base station 105, depending on context.

A macro cell may cover a relatively large geographic area (e.g., several kilometers in radius) and may allow unrestricted access by UEs 115 with service subscriptions with the network provider. A small cell may be a lower-powered base station 105, as compared with a macro cell that may operate in the same or different (e.g., licensed, shared, etc.) radio frequency spectrum bands as macro cells. Small cells may include pico cells, femto cells, and micro cells according to various examples. A pico cell may cover a relatively smaller geographic area and may allow unrestricted access by UEs 115 with service subscriptions with the network provider. A femto cell also may cover a relatively small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or packet data convergence protocol (PDCP) layer may be IP-based. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARQ) to provide retransmission at the MAC layer to improve link efficiency. In the control plane, the radio resource control (RRC) protocol layer may provide establishment, configuration, and maintenance of an RRC connection between a UE 115 and the base stations 105 or core network 130 supporting radio bearers for the user plane data. At the physical layer, the transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations 105 and network equipment, including macro eNBs, small cell eNBs, relay base stations, and the like.

The communication links 125 shown in wireless communication system 100 may include downlink (DL) transmissions, from a base station 105 to a UE 115, or uplink (UL) transmissions, from a UE 115 to a base station 105. The DL transmissions may also be called forward link transmissions, while the UL transmissions may also be called reverse link transmissions.

In some examples, each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using a frequency domain duplexing (FDD) operation (e.g., using paired spectrum resources) or a time domain duplexing (TDD) operation (e.g., using unpaired spectrum resources). Frame structures for FDD operation (e.g., frame structure type 1) and TDD operation (e.g., frame structure type 2) may be defined.

In some examples of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple-input multiple-output (MIMO) techniques that may take advantage of multi-path environments to transmit multiple spatial layers carrying the same or different coded data.

The wireless communication system 100 may support operation on multiple cells or carriers, a feature which may be referred to as carrier aggregation (CA) or dual-connectivity operation. A carrier may also be referred to as a component carrier (CC), a layer, a channel, etc. The terms “carrier,” “component carrier,” “cell,” and “channel” may be used interchangeably herein. CA may be used with both FDD and TDD CCs.

In an LTE/LTE-A network, a UE 115 may be configured to communicate using up to five CCs when operating in a CA mode or dual-connectivity mode. One or more of the CCs may be configured as a DL CC, and one or more of the CCs may be configured as a UL CC. Also, one of the CCs allocated to a UE 115 may be configured as a primary CC (PCC), and the remaining CCs allocated to the UE 115 may be configured as secondary CCs (SCCs).

In some examples, the wireless communication system 100 may support operation over a dedicated radio frequency spectrum band (e.g., a radio frequency spectrum band for which transmitting apparatuses may not contend for access because the radio frequency spectrum band is licensed to users for different uses (e.g., a licensed radio frequency spectrum band usable for LTE/LTE-A communications)) or a shared radio frequency spectrum band (e.g., a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner)). Upon winning a contention for access to the shared radio frequency spectrum band, a transmitting apparatus (e.g., a base station 105 or UE 115) may transmit one or more CUBS over the shared radio frequency spectrum band. The CUBS may reserve the shared radio frequency spectrum band by providing a detectable energy on the shared radio frequency spectrum band. The CUBS may also serve to identify the transmitting apparatus or serve to synchronize the transmitting apparatus and a receiving apparatus.

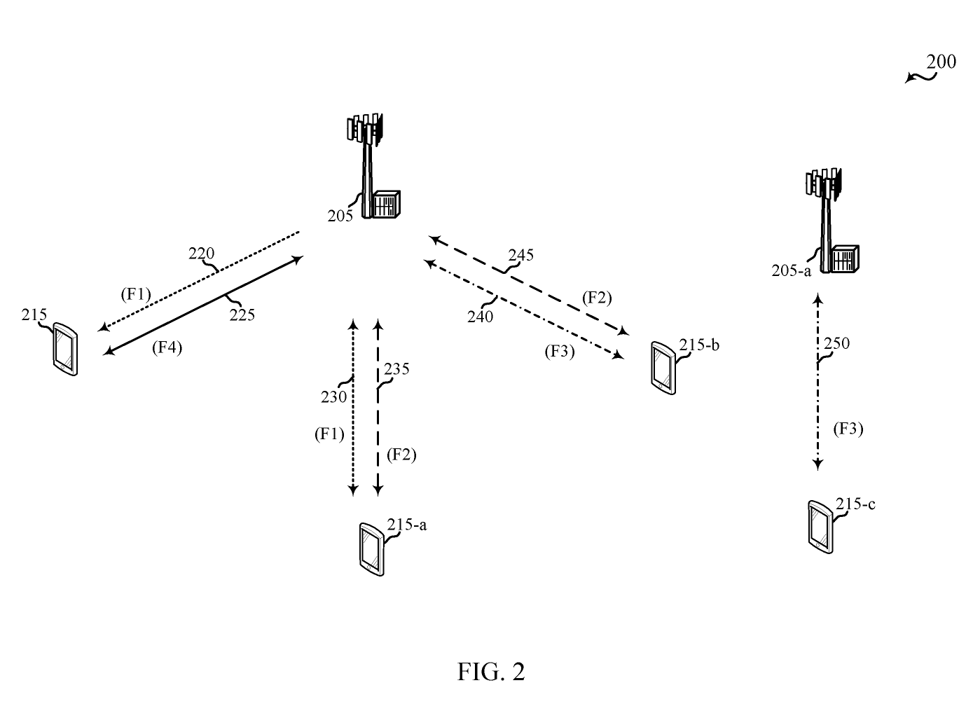

FIG. 2 shows a wireless communication system 200 in which LTE/LTE-A may be deployed under different scenarios using a shared radio frequency spectrum band, in accordance with various aspects of the present disclosure. More specifically, FIG. 2 illustrates examples of a supplemental DL mode (also referred to as a licensed assisted access mode), a CA mode, and a standalone mode in which LTE/LTE-A is deployed using a shared radio frequency spectrum band. The wireless communication system 200 may be an example of portions of the wireless communication system 100 described with reference to FIG. 1. Moreover, a first base station 205 and a second base station 205-a may be examples of aspects of one or more of the base stations 105 described with reference to FIG. 1, while a first UE 215, a second UE 215-a, a third UE 215-b, and a fourth UE 215-c may be examples of aspects of one or more of the UEs 115 described with reference to FIG. 1.

In the example of a supplemental downlink mode (e.g., a licensed assisted access mode) in the wireless communication system 200, the first base station 205 may transmit orthogonal frequency division multiple access (OFDMA) waveforms to the first UE 215 using a DL channel 220. The DL channel 220 may be associated with a frequency F1 in a shared radio frequency spectrum band. The first base station 205 may transmit OFDMA waveforms to the first UE 215 using a first bidirectional link 225 and may receive single carrier frequency division multiple access (SC-FDMA) waveforms from the first UE 215 using the first bidirectional link 225. The first bidirectional link 225 may be associated with a frequency F4 in a dedicated radio frequency spectrum band. The DL channel 220 in the shared radio frequency spectrum band and the first bidirectional link 225 in the dedicated radio frequency spectrum band may operate contemporaneously. The DL channel 220 may provide a DL capacity offload for the first base station 205. In some examples, the DL channel 220 may be used for unicast services (e.g., addressed to one UE) or for multicast services (e.g., addressed to several UEs). This scenario may occur with any service provider (e.g., a mobile network operator (MNO)) that uses a dedicated radio frequency spectrum and needs to relieve some of the traffic or signaling congestion.

In one example of a carrier aggregation mode in the wireless communication system 200, the first base station 205 may transmit OFDMA waveforms to the second UE 215-a using a second bidirectional link 230 and may receive OFDMA waveforms, SC-FDMA waveforms, or resource block interleaved frequency division multiple access (FDMA) waveforms from the second UE 215-a using the second bidirectional link 230. The second bidirectional link 230 may be associated with the frequency F1 in the shared radio frequency spectrum band. The first base station 205 may also transmit OFDMA waveforms to the second UE 215-a using a third bidirectional link 235 and may receive SC-FDMA waveforms from the second UE 215-a using the third bidirectional link 235. The third bidirectional link 235 may be associated with a frequency F2 in a dedicated radio frequency spectrum band. The second bidirectional link 230 may provide a DL and UL capacity offload for the first base station 205. Like the supplemental DL mode (e.g., licensed assisted access mode) described above, this scenario may occur with any service provider (e.g., MNO) that uses a dedicated radio frequency spectrum and needs to relieve some of the traffic or signaling congestion.

In another example of a carrier aggregation mode in the wireless communication system 200, the first base station 205 may transmit OFDMA waveforms to the third UE 215-b using a fourth bidirectional link 240 and may receive OFDMA waveforms, SC-FDMA waveforms, or resource block (RB) interleaved waveforms from the third UE 215-b using the fourth bidirectional link 240. The fourth bidirectional link 240 may be associated with a frequency F3 in the shared radio frequency spectrum band. The first base station 205 may also transmit OFDMA waveforms to the third UE 215-b using a fifth bidirectional link 245 and may receive SC-FDMA waveforms from the third UE 215-b using the fifth bidirectional link 245. The fifth bidirectional link 245 may be associated with the frequency F2 in the dedicated radio frequency spectrum band. The fourth bidirectional link 240 may provide a DL and UL capacity offload for the first base station 205. This example and those provided above are presented for illustrative purposes and there may be other similar modes of operation or deployment scenarios that combine LTE/LTE-A in a dedicated radio frequency spectrum band and use a shared radio frequency spectrum band for capacity offload.

As described above, one type of service provider that may benefit from the capacity offload offered by using LTE/LTE-A in a shared radio frequency spectrum band is a traditional MNO having access rights to an LTE/LTE-A dedicated radio frequency spectrum band. For these service providers, an operational example may include a bootstrapped mode (e.g., supplemental DL, CA) that uses the LTE/LTE-A PCC on the dedicated radio frequency spectrum band and at least one SCC on the shared radio frequency spectrum band.

In the CA mode, data and control may, for example, be communicated in the dedicated radio frequency spectrum band (e.g., via first bidirectional link 225, third bidirectional link 235, and fifth bidirectional link 245) while data may, for example, be communicated in the shared radio frequency spectrum band (e.g., via second bidirectional link 230 and fourth bidirectional link 240). The CA mechanisms supported when using a shared radio frequency spectrum band may fall under a hybrid frequency division duplexing-time division duplexing (FDD-TDD) CA or a TDD-TDD CA with different symmetry across component carriers.

In one example of a standalone mode in the wireless communication system 200, the second base station 205-a may transmit OFDMA waveforms to the fourth UE 215-c using a bidirectional link 250 and may receive OFDMA waveforms, SC-FDMA waveforms, or RB interleaved FDMA waveforms from the fourth UE 215-c using the bidirectional link 250. The bidirectional link 250 may be associated with the frequency F3 in the shared radio frequency spectrum band. The standalone mode may be used in non-traditional wireless access scenarios, such as in-stadium access (e.g., unicast, multicast). An example of a type of service provider for this mode of operation may be a stadium owner, cable company, event host, hotel, enterprise, or large corporation that does not have access to a dedicated radio frequency spectrum band.

In some examples, a transmitting apparatus such as one of the base stations 105, 205, or 205-a described with reference to FIG. 1 or 2, or one of the UEs 115, 215, 215-a, 215-b, or 215-c described with reference to FIG. 1 or 2, may use a gating interval to gain access to a channel of a shared radio frequency spectrum band (e.g., to a physical channel of the shared radio frequency spectrum band). In some examples, the gating interval may be periodic. For example, the periodic gating interval may be synchronized with at least one boundary of an LTE/LTE-A radio interval. The gating interval may define the application of a contention-based protocol, such as an LBT protocol based on the LBT protocol specified in European Telecommunications Standards Institute (ETSI) (EN 301 893). When using a gating interval that defines the application of an LBT protocol, the gating interval may indicate when a transmitting apparatus needs to perform a contention procedure (e.g., an LBT procedure) such as a CCA procedure. The outcome of the CCA procedure may indicate to the transmitting apparatus whether a channel of a shared radio frequency spectrum band is available or in use for the gating interval (also referred to as an LBT radio frame). When a CCA procedure indicates that the channel is available for a corresponding LBT radio frame (e.g., “clear” for use), the transmitting apparatus may reserve or use the channel of the shared radio frequency spectrum band during part or all of the LBT radio frame. When the CCA procedure indicates that the channel is not available (e.g., that the channel is in use or reserved by another transmitting apparatus), the transmitting apparatus may be prevented from using the channel during the LBT radio frame.

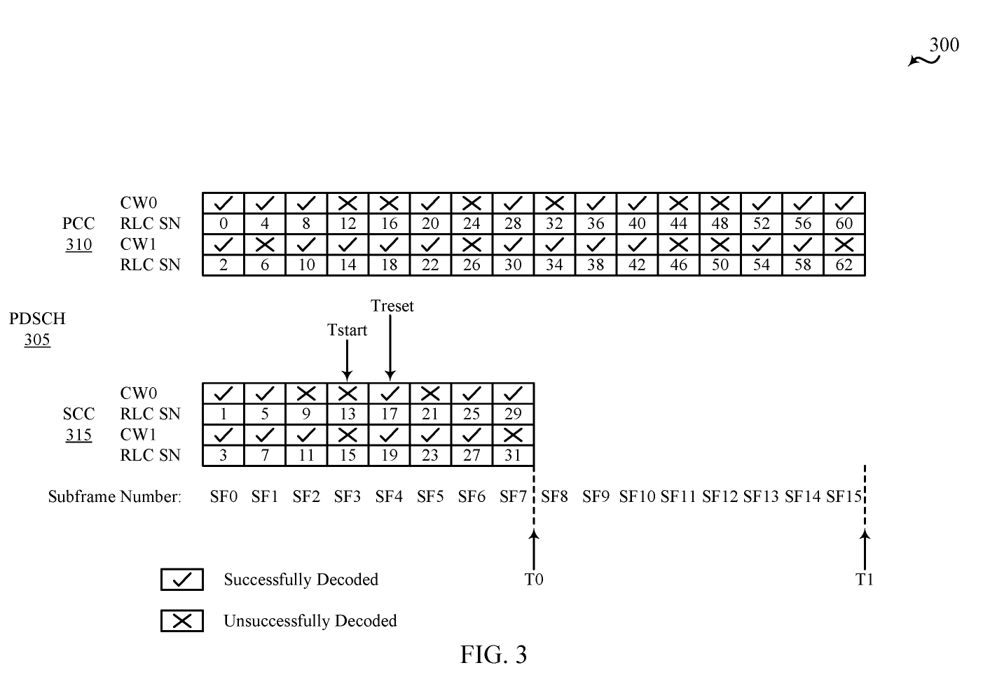

FIG. 3 shows a timeline 300 of physical layer packet reception at a UE, in accordance with various aspects of the present disclosure. In some examples, the UE may be an example of aspects of one or more of the UEs 115, 215, 215-a, 215-b, or 215-c described with reference to FIG. 1 or 2.

As shown in FIG. 3, a UE may receive a physical channel (e.g., a physical downlink shared channel (PDSCH) 305) from a base station. The physical channel may be received over a number of subframes (e.g., a first subframe (SF0), a second subframe (SF1), etc.) and include a plurality of codewords. The plurality of codewords may be distributed across a PCC 310 and an SCC 315 (and in some examples, across one or more additional SCCs). By way of example, the physical channel is shown to include four codewords (e.g., a first codeword (CW0) and a second codeword (CW1) received on the PCC 310, and a third codeword (CW0) and a fourth codeword (CW1) received on the SCC 315). A plurality of physical layer packets (e.g., RLC packets) in a sequence of physical layer packets may be received on the physical channel. For example, physical layer packets associated with sequence numbers 0 (RLC SN 0), 4 (RLC SN 4), etc. may be received on the first codeword (CW0) on the PCC 310; physical layer packets associated with sequence numbers 1, 5, etc. may be received on the third codeword (CW0) on the SCC 315; physical layer packets associated with sequence numbers 2, 6, etc. may be received on the second codeword (CW1) on the PCC 310; and physical layer packets associated with sequence numbers 3, 7, etc. may be received on the fourth codeword (CW1) on the SCC 315.

In some examples, communications on the PCC 310 may be made in a dedicated radio frequency spectrum band, and communications on the SCC 315 may be made in a shared radio frequency spectrum band. In other examples, communications on the PCC 310 and the SCC 315 may be made in the shared radio frequency spectrum band. The dedicated radio frequency spectrum band may include a radio frequency spectrum band for which transmitting apparatuses may not contend for access (e.g., a radio frequency spectrum band licensed to users for various uses, such as a licensed radio frequency spectrum band usable for LTE/LTE-A communications). The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner).

Upon successfully decoding a physical layer packet (e.g., an RLC packet associated with RLC sequence number (SN)0), the UE may add the RLC packet to an RLC reordering queue. Upon unsuccessfully decoding a physical layer packet (e.g., an RLC packet associated with RLC SN 12), the UE may transmit a negative acknowledgement (NAK) of a physical channel packet containing the RLC packet (e.g., when not prohibited from doing so by a status prohibit timer) and initiate (e.g., start) an RLC reordering timer. In some examples, a base station may retransmit a NAK'd physical channel packet at least eight subframes after a prior transmission of the physical channel packet. For example, the physical layer packet associated with RLC SN 12 is retransmitted in subframe SF 11, eight subframes after its prior transmission in subframe SF 3. When an RLC packet included in a NAK'd physical channel packet is not successfully decoded after one or more retransmission attempts, a non-received RLC packet associated with the NAK'd physical channel packet may be NAK'd in an RLC status report transmitted upon expiration of the RLC reordering timer. In some examples, the RLC reordering timer may have a duration of 40 milliseconds.

According to the timeline 300, the SCC 315 becomes inactive at time TO following subframe SF 7. Inactivity on the SCC 315 may occur, for example, as a result of a base station with which the UE communicates (and/or the UE) losing contention for access to the shared radio frequency spectrum band. As a result, retransmissions of physical layer packets associated with NAK'd physical channel packets received on the SCC 315 may not occur (i.e., because the SCC 315, on which the retransmissions would be received, is inactive). However, despite retransmissions on the SCC 315 being unable to occur, because the SCC is inactive, the UE may nonetheless wait for the physical layer packet retransmissions because an RLC reordering timer is not expired.

According to techniques described in the present disclosure, the UE may avoid the delay imposed by the RLC reordering timer by identifying a decoding status of one or more physical layer packets before inactivity on SCC 315 in the shared radio frequency spectrum band (e.g., the eight subframes SF0 through SF7); initiating an SCC reordering timer, where the reordering timer is initiated when the decoding status of one or more physical layer codewords are identified as unsuccessful; and trigger an early transmission of an RLC status report upon the expiration of the SCC reordering timer. The RLC status report may be considered “early” because it is transmitted before the expiration of an RLC reordering timer initiated when the decoding status of one or more physical layer packets is identified as unsuccessful. In some cases, the RLC status report includes a status for physical layer packets associated with sequence numbers preceding a sequence number of a first physical layer packet received after the inactivity on SCC 315. In some examples, the triggered transmission of the RLC status report may be based at least in part on the unsuccessful decoding status being associated with the SCC 315 (e.g., because the inactivity of the SCC 315, at time T0, prohibits the UE from receiving retransmissions of the unsuccessfully decoded physical layer packets associated with RLC SNs 9, 13, 15, 21, 27, and 31 on the SCC 315 because of failure at the physical layer).

In the example shown in FIG. 3, a UE may monitor the decoding status of each subframe in SCC 315, and the SCC reordering timer may be started after a physical layer packet is unsuccessfully decoded. In some cases, the UE may successfully decode the physical layer packets associated with RLC SN 1 and RLC SN 5 in SCC 315 (received during SF0 and SF1, respectively). Accordingly, the UE may refrain from starting the SCC reordering timer because physical channel packets have been successfully received. However, the UE may unsuccessfully decode the physical layer packets associated with RLC SN 9 on the SCC 315, and decoding the physical layer packets associated with RLC SN 13 may also be unsuccessful. Thus, the UE may initiate the SCC reordering timer, at time Tstart, due to unsuccessful decoding of one or more physical layer packets on SCC 315. The SCC reordering timer may run simultaneous to the RLC reordering timer initiated when the decoding status of one or more physical layer packets is identified as unsuccessful.

In some cases, the SCC reordering timer may be set to a default duration (e.g., 24 ms). Additionally or alternatively, the duration of the SCC reordering timer may be dynamically configured (e.g., changed from 24 ms to 30 ms), such as a duration dynamically configured based at least in part on a history of SCC inactivity times. For example, the UE may determine, over a preceding period of time (e.g., the past one or two seconds), how long SCC 315 was inactive before the base station started transmitting on SCC 315 again. The UE may use this history of SCC inactivity times to configure the duration of the SCC reordering timer to enable efficient transmission of the RLC status report.

After initiating the SCC reordering timer at time Tstart, the UE may subsequently receive a physical layer packet associated with RLC SN 17 on SCC 315. As a result, the UE may stop and reset the SCC reordering timer, at time Treset, due to the received physical layer packet. In some cases, the SCC reordering timer may be started and then reset at multiple instances of SCC 315. Alternatively, if there are no unsuccessfully decoded physical layer packets during SCC 315, the SCC reordering timer may not be started.

In the example shown in FIG. 3, the SCC 315 may become inactive at time T0 and, due to an unsuccessful decoding of a physical layer packet on SCC 315 (a failed HARQ process on SCC 315), the SCC reordering timer may continue to run. Accordingly, the SCC reordering timer may expire and the UE may send an RLC status report upon the expiration of the SCC reordering timer. In some examples, the information regarding NAK'd physical channel packets may be retained and retransmitted at a later time (e.g., in a subsequent subframe). In the example shown in FIG. 3, an RLC status report triggered at time T0 may be generated and transmitted at time Ti. In some examples, the RLC status report may be transmitted on the PCC 310 in the dedicated radio frequency spectrum band.

In some examples, a UE may assign a decode status with different HARQ process numbers. The decode status may have different values (e.g., 0, 1, and 2), where a decode status value 0 may indicate the presence of an unsuccessfully decoded physical layer packet in a HARQ buffer, a decode status value 1 may indicate that there are no physical layer packets present in the HARQ buffer, and a decode status value of 2 may indicate that there are unsuccessfully decoded physical layer packets present in the HARQ buffer, but are marked as a “fake pass” so that an SCC reordering timer is not triggered. An example of the decode status associated with different transport blocks (TBs) for SCC HARQ process numbers is illustrated in Table 1.

TABLE 1

| SCC HARQ process # | Decode Status-TB0 | Decode Status-TB1 |
|---|---|---|
| 0 | 1 | 0 |
| 1 | 1 | 1 |
| 2 | 0 | 1 |
| 3 | 1 | 0 |
| 4 | 1 | 1 |
| 5 | 1 | 1 |
| 6 | 1 | 1 |
| 7 | 1 | 1 |

In the example given in Table 1, there are a total of eight HARQ processes associated with two TBs (e.g., TB0 and TB1). At HARQ process 2, the decode status 0 reflects a HARQ process failure (e.g., a cyclic redundancy check (CRC) failure) for TB. Similarly, the decode status for HARQ processes numbers 0 and 3 reflect a HARQ process failure for TB1. In some cases, the remaining entries in Table 1 (e.g., those reflecting decode status 1) show that the physical layer packets either were not transmitted, or if the physical layer packets were transmitted, the HARQ process passed. In some examples, Table 1 may be maintained in the physical layer.

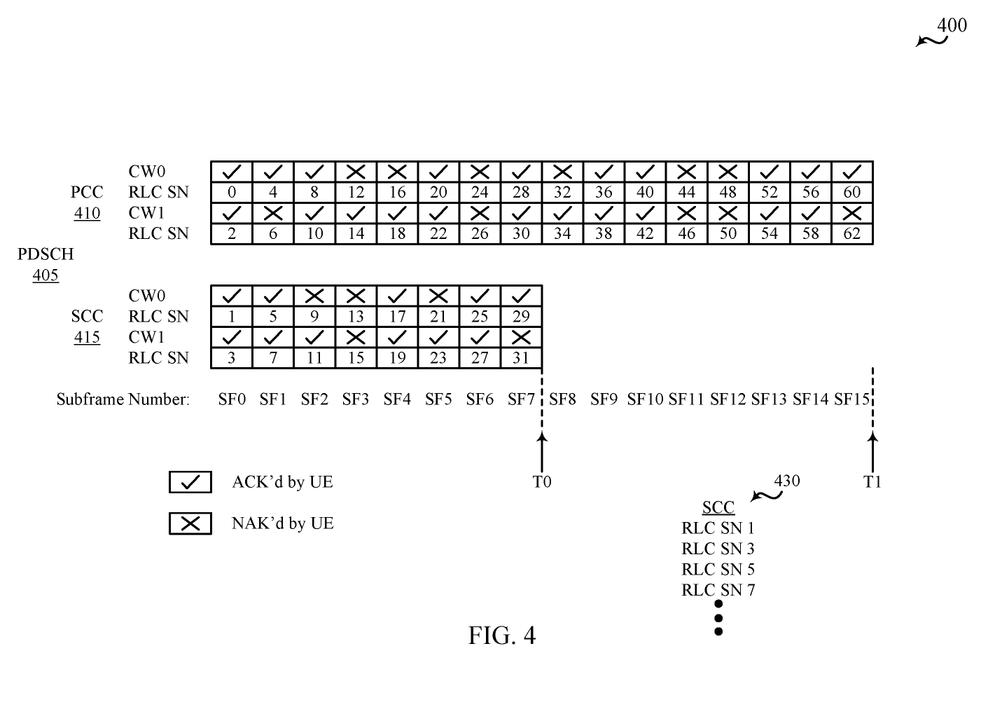

FIG. 4 shows a timeline 400 of physical layer packet transmission at a base station, in accordance with various aspects of the present disclosure. In some examples, the base station may be an example of aspects of one or more of the base stations 105, 205, or 205-a described with reference to FIG. 1 or 2.

As shown in FIG. 4, a base station may transmit a physical channel (e.g., a PDSCH 405) to a UE. The physical channel may be transmitted over a number of subframes (e.g., a first subframe (SF0), a second subframe (SF1), etc.) and include a plurality of codewords. The plurality of codewords may be distributed across a PCC 410 and an SCC 415 (and in some examples, across one or more additional SCCs). By way of example, the physical channel is shown to include four codewords (e.g., a first codeword (CW0) and a second codeword (CW1) transmitted on the PCC 410, and a third codeword (CW0) and a fourth codeword (CW1) transmitted on the SCC 415). A plurality of physical layer packets in a sequence of physical layer packets may be transmitted on the physical channel. For example, physical layer packets associated with sequence numbers 0 (RLC SN 0), 4 (RLC SN 4), etc. may be transmitted on the first codeword (CW0) on the PCC 410; physical layer packets associated with sequence numbers 1, 5, etc. may be transmitted on the third codeword (CW0) on the SCC 415; physical layer packets associated with sequence numbers 2, 6, etc. may be transmitted on the second codeword (CW1) on the PCC 410; and physical layer packets associated with sequence numbers 3, 7, etc. may be transmitted on the fourth codeword (CW1) on the SCC 415.

In some examples, communications on the PCC 410 may be made in a dedicated radio frequency spectrum band, and communications on the SCC 415 may be made in a shared radio frequency spectrum band. In other examples, communications on the PCC 410 and the SCC 415 may be made in the shared radio frequency spectrum band. The dedicated radio frequency spectrum band may include a radio frequency spectrum band for which transmitting apparatuses may not contend for access (e.g., a radio frequency spectrum band licensed to users for various uses, such as a licensed radio frequency spectrum band usable for LTE/LTE-A communications). The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner).

In some examples, the base station may maintain a mapping 430 between the sequence of physical layer packets and the physical channel. The mapping 430 is maintained for at least the SCC 415, but may also be maintained for the PCC 410. The mapping 430 may enable the base station to retransmit at least one physical layer packet (e.g., physical layer packets associated with RLC SNs 9, 13, 15, 21, 27, and 31) to the UE based at least in part on determining the SCC is inactive (e.g., at time T0) and determining at least one transmission on the physical channel is negatively acknowledged by the UE. The at least one transmission on the physical channel may correspond to the at least one physical layer packet. In some examples, the retransmitting may occur on the PCC 410 in the dedicated radio frequency spectrum band.

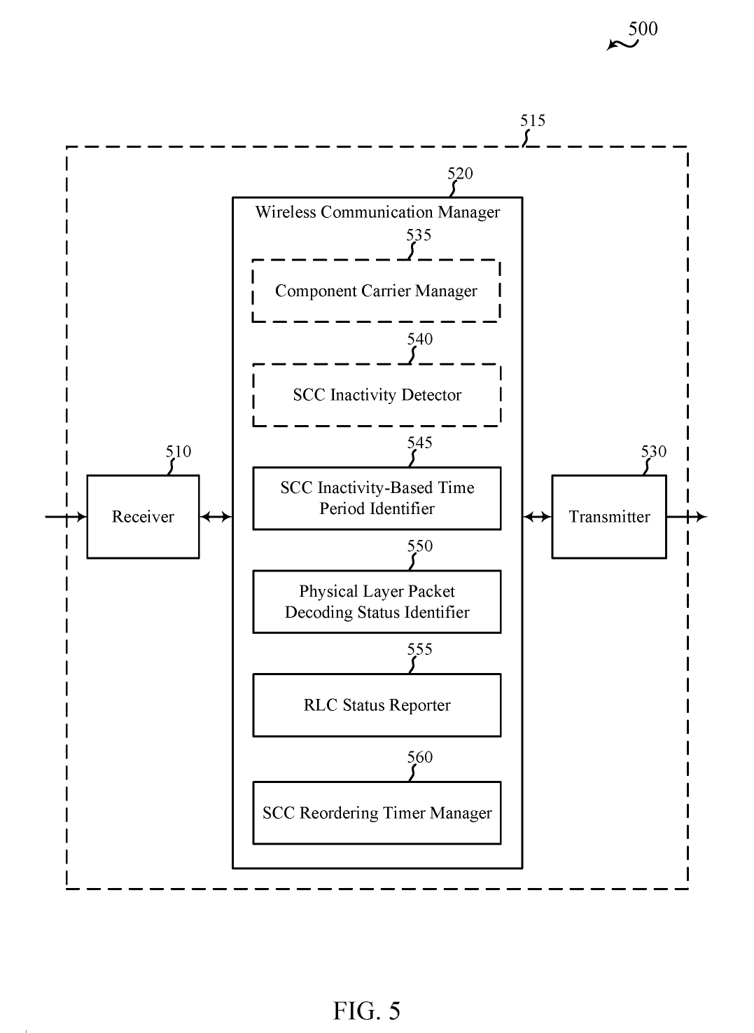

FIG. 5 shows a block diagram 500 of an apparatus 515 for use in wireless communication, in accordance with various aspects of the present disclosure. The apparatus 515 may be an example of aspects of one or more of the UEs 115, 215, 215-a, 215-b, or 215-c described with reference to FIG. 1 or 2. The apparatus 515 may also be or include a processor. The apparatus 515 may include a receiver 510, a wireless communication manager 520, or a transmitter 530. Each of these components may be in communication with each other.

The components of the apparatus 515 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., structured/platform ASICs, field programmable gate arrays (FPGAs), a system-on-chip (SoC), and/or other types of semi-custom ICs), which may be programmed in any manner known in the art. The functions of each component may also be implemented, in whole or in part, with instructions embodied in a memory, formatted to be executed by one or more general or application-specific processors.

In some examples, the receiver 510 may include at least one radio frequency (RF) receiver, such as at least one RF receiver operable to receive transmissions over a dedicated radio frequency spectrum band (e.g., a radio frequency spectrum band for which transmitting apparatuses may not contend for access because the radio frequency spectrum band is licensed to users for various uses) or a shared radio frequency spectrum band (e.g., a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner)). In some examples, the dedicated radio frequency spectrum band or the shared radio frequency spectrum band may be used for LTE/LTE-A communications, as described, for example, with reference to FIG. 1, 2, 3, or 4. The receiver 510 may be used to receive various types of data or control signals (i.e., transmissions) over one or more communication links of a wireless communication system, such as one or more communication links of the wireless communication system 100 or 200 described with reference to FIG. 1 or 2. The communication links may be established over the first radio frequency spectrum band or the second radio frequency spectrum band.

In some examples, the transmitter 530 may include at least one RF transmitter, such as at least one RF transmitter operable to transmit over the dedicated radio frequency spectrum band or the shared radio frequency spectrum band. The transmitter 530 may be used to transmit various types of data or control signals (i.e., transmissions) over one or more communication links of a wireless communication system, such as one or more communication links of the wireless communication system 100 or 200 described with reference to FIG. 1 or 2. The communication links may be established over the dedicated radio frequency spectrum band or the shared radio frequency spectrum band.

In some examples, the wireless communication manager 520 may be used to manage one or more aspects of wireless communication for the apparatus 515. In some examples, part of the wireless communication manager 520 may be incorporated into or shared with the receiver 510 or the transmitter 530. In some examples, the wireless communication manager 520 may include an optional component carrier manager 535, an optional SCC inactivity detector 540, an SCC inactivity-based time period identifier 545, a physical layer packet decoding status identifier 550, an RLC status reporter 555, or an SCC reordering timer manager 560.

The component carrier manager 535 may be used to manage communications with one or more base stations on a PCC and an SCC. In some examples, communications on the PCC may be made in the dedicated radio frequency spectrum band, and communications on the SCC may be made in the shared radio frequency spectrum band. In other examples, communications on the PCC and the SCC may be made in the shared radio frequency spectrum band. In some examples, the component carrier manager 535 may manage communications with the one or more base stations on a PCC and multiple SCCs. Communication on at least one of the multiple SCCs may be in the shared radio frequency spectrum band, and communication on the other SCC(s) may be in the shared radio frequency spectrum band and/or the dedicated radio frequency spectrum band.

The SCC inactivity detector 540 may be used to identify inactivity on an SCC in the shared radio frequency spectrum band. The inactivity on the SCC may occur, for example, as a result of a base station with which the apparatus 515 communicates on the SCC (and/or the apparatus 515) losing contention for access to the shared radio frequency spectrum band. Communication between the apparatus 515 and a base station on the PCC, and possibly on one or more other SCCs, may continue after the SCC becomes inactive. In some examples, SCC inactivity detector 540 may identify inactivity on the SCC in the shared radio frequency spectrum band when physical channel packets are no longer received on the SCC.

The SCC inactivity-based time period identifier 545 may be used to identify a threshold time period for which the SCC has remained inactive in the shared radio frequency spectrum band. In some examples, the threshold time period may have a duration of 24 subframes or 24 milliseconds. The physical layer decoding status identifier 550 may be used to identify a decoding status of one or more physical layer packets during the threshold time period. In some cases, the physical layer decoding status identifier 550 may identify a decoding status of one or more physical layer packets received on an SCC when the SCC was active in a shared radio frequency band.

The RLC status reporter 555 may be used to trigger a transmission, to a base station, of an RLC status report. In some cases, the RLC status report may be transmitted upon the expiration of an SCC reordering timer. The RLC status report may be transmitted before expiration of an RLC reordering timer initiated by the physical layer decoding status identifier 550 when the decoding status of the one or more physical layer packets received on SCC is identified as unsuccessful.

The SCC reordering timer manager 560 may be used to initiate an SCC reordering timer, where the SCC reordering timer is initiated when the decoding status of the one or more physical layer packets received on SCC is identified as unsuccessful. In some cases, the SCC reordering timer manager 560 may stop and reset the SCC reordering timer when the physical layer packet is received on the SCC. In some examples, the SCC reordering timer may have a predetermined duration (e.g., 24 ms), or may have a dynamically configured duration, such as a duration based on a history of SCC inactivity periods.

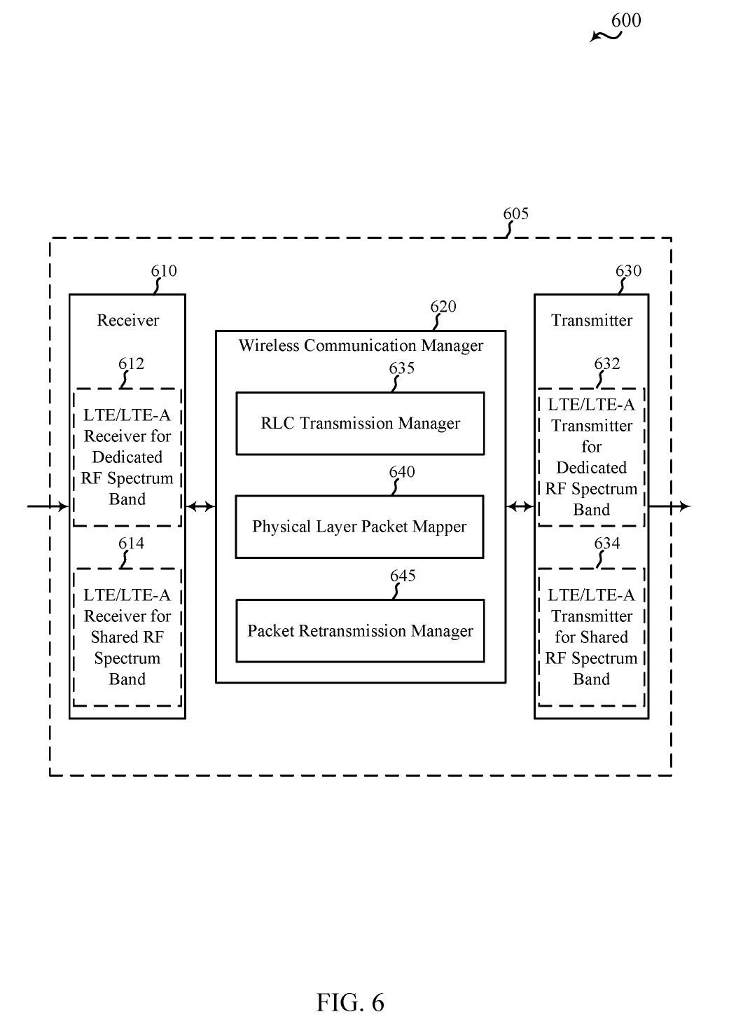

FIG. 6 shows a block diagram 600 of an apparatus 605 for use in wireless communication, in accordance with various aspects of the present disclosure. The apparatus 605 may be an example of aspects of one or more of the base stations 105, 205, or 205-a described with reference to FIG. 1 or 2. The apparatus 605 may also be or include a processor. The apparatus 605 may include a receiver 610, a wireless communication manager 620, or a transmitter 630. Each of these components may be in communication with each other.

The components of the apparatus 605 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., structured/platform ASICs, FPGAs, a SoC, and/or other types of semi-custom ICs), which may be programmed in any manner known in the art. The functions of each component may also be implemented, in whole or in part, with instructions embodied in a memory, formatted to be executed by one or more general or application-specific processors.

In some examples, the receiver 610 may include at least one RF receiver, such as at least one RF receiver operable to receive transmissions over a dedicated radio frequency spectrum band (e.g., a radio frequency spectrum band for which transmitting apparatuses may not contend for access because the radio frequency spectrum band is licensed to users for various uses) or a shared radio frequency spectrum band (e.g., a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner)). In some examples, the dedicated radio frequency spectrum band or the shared radio frequency spectrum band may be used for LTE/LTE-A communications, as described, for example, with reference to FIG. 1, 2, 3, or 4.

The receiver 610 may in some cases include separate receivers for the dedicated radio frequency spectrum band and the shared radio frequency spectrum band. The separate receivers may, in some examples, take the form of an LTE/LTE-A receiver for communicating over the dedicated radio frequency spectrum band (e.g., LTE/LTE-A receiver for dedicated RF spectrum band 612), and an LTE/LTE-A receiver for communicating over the shared radio frequency spectrum band (e.g., LTE/LTE-A receiver for shared RF spectrum band 614). The receiver 610, including the LTE/LTE-A receiver for dedicated RF spectrum band 612 or the LTE/LTE-A receiver for shared RF spectrum band 614, may be used to receive various types of data or control signals (i.e., transmissions) over one or more communication links of a wireless communication system, such as one or more communication links of the wireless communication system 100 or 200 described with reference to FIG. 1 or 2. The communication links may be established over the dedicated radio frequency spectrum band or the shared radio frequency spectrum band.

In some examples, the transmitter 630 may include at least one RF transmitter, such as at least one RF transmitter operable to transmit over the dedicated radio frequency spectrum band or the shared radio frequency spectrum band. The transmitter 630 may in some cases include separate transmitters for the dedicated radio frequency spectrum band and the shared radio frequency spectrum band. The separate transmitters may, in some examples, take the form of an LTE/LTE-A transmitter for communicating over the dedicated radio frequency spectrum band (e.g., LTE/LTE-A transmitter for dedicated RF spectrum band 632), and an LTE/LTE-A transmitter for communicating over the shared radio frequency spectrum band (e.g., LTE/LTE-A transmitter for shared RF spectrum band 634). The transmitter 630, including the LTE/LTE-A transmitter for dedicated RF spectrum band 632 or the LTE/LTE-A transmitter for shared RF spectrum band 634, may be used to transmit various types of data or control signals (i.e., transmissions) over one or more communication links of a wireless communication system, such as one or more communication links of the wireless communication system 100 or 200 described with reference to FIG. 1 or 2. The communication links may be established over the dedicated radio frequency spectrum band or the shared radio frequency spectrum band.

In some examples, the wireless communication manager 620 may be used to manage one or more aspects of wireless communication for the apparatus 605. In some examples, part of the wireless communication manager 620 may be incorporated into or shared with the receiver 610 or the transmitter 630. In some examples, the wireless communication manager 620 may include an RLC transmission manager 635, a physical layer packet mapper 640, or a packet retransmission manager 645.

The RLC transmission manager 635 may be used to transmit a sequence of physical layer packets to a UE. The physical layer packet mapper 640 may be used to maintain a mapping between the sequence of physical layer packets and a physical channel transmitted to the UE on an SCC in the shared radio frequency spectrum band. The packet retransmission manager 645 may be used to retransmit at least one physical layer packet to the UE based at least in part on determining the SCC is inactive and determining at least one transmission on the physical channel is negatively acknowledged. The at least one transmission on the physical channel may correspond to the at least one physical layer packet. In some examples, the retransmitting may occur on a PCC in a dedicated radio frequency spectrum band.

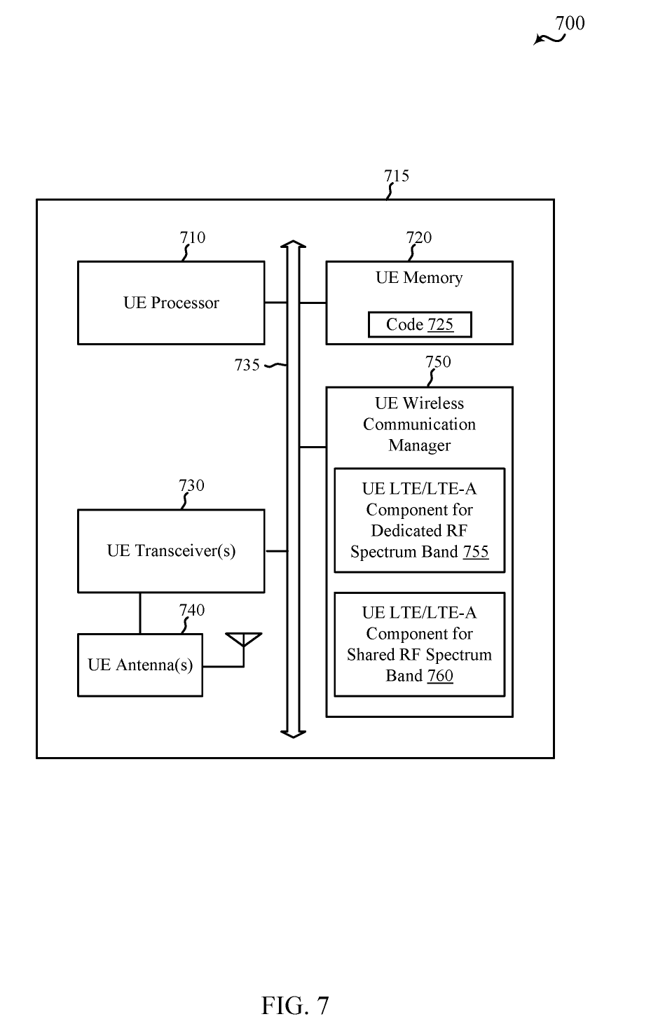

FIG. 7 shows a block diagram 700 of a UE 715 for use in wireless communication, in accordance with various aspects of the present disclosure. The UE 715 may be included or be part of a personal computer (e.g., a laptop computer, a netbook computer, a tablet computer, etc.), a cellular telephone, a PDA, a DVR, an internet appliance, a gaming console, an e-reader, etc. The UE 715 may, in some examples, have an internal power supply (not shown), such as a small battery, to facilitate mobile operation. In some examples, the UE 715 may be an example of aspects of one or more of the UEs 115, 215, 215-a, 215-b, or 215-c described with reference to FIG. 1 or 2, or aspects of the apparatus 515 described with reference to FIG. 5. The UE 715 may be configured to implement at least some of the UE or apparatus techniques and functions described with reference to FIG. 1, 2, 3, 4, 5, or 6.

The UE 715 may include a UE processor 710, a UE memory 720, at least one UE transceiver (represented by UE transceiver(s) 730), at least one UE antenna (represented by UE antenna(s) 740), or a UE wireless communication manager 750. Each of these components may be in communication with each other, directly or indirectly, over one or more buses 735.

The UE memory 720 may include random access memory (RAM) or read-only memory (ROM). The UE memory 720 may store computer-readable, computer-executable code 725 containing instructions that are configured to, when executed, cause the UE processor 710 to perform various functions described herein related to wireless communication, including, for example, triggering a transmission or an RLC status report to a base station before the expiration of an RLC reordering timer. Alternatively, the computer-executable code 725 may not be directly executable by the UE processor 710 but be configured to cause the UE 715 (e.g., when compiled and executed) to perform various of the functions described herein.

The UE processor 710 may include an intelligent hardware device, e.g., a central processing unit (CPU), a microcontroller, an ASIC, etc. The UE processor 710 may process information received through the UE transceiver(s) 730 or information to be sent to the UE transceiver(s) 730 for transmission through the UE antenna(s) 740. The UE processor 710 may handle, alone or in connection with the UE wireless communication manager 750, various aspects of communicating over (or managing communications over) a dedicated radio frequency spectrum band or the shared radio frequency spectrum band. The dedicated radio frequency spectrum band may include a radio frequency spectrum band for which transmitting apparatuses may not contend for access (e.g., a radio frequency spectrum band licensed to users for various uses, such as a licensed radio frequency spectrum band usable for LTE/LTE-A communications). The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner).

The UE transceiver(s) 730 may include a modem configured to modulate packets and provide the modulated packets to the UE antenna(s) 740 for transmission, and to demodulate packets received from the UE antenna(s) 740. The UE transceiver(s) 730 may, in some examples, be implemented as one or more UE transmitters and one or more separate UE receivers. The UE transceiver(s) 730 may support communications in the dedicated radio frequency spectrum band or the shared radio frequency spectrum band. The UE transceiver(s) 730 may be configured to communicate bi-directionally, via the UE antenna(s) 740, with one or more of the base stations 105, 205, or 205-a described with reference to FIG. 1 or 2, or the apparatus 605 described with reference to FIG. 6. While the UE 715 may include a single UE antenna, there may be examples in which the UE 715 may include multiple UE antennas 740.

The UE wireless communication manager 750 may be configured to perform or control some or all of the UE or apparatus techniques or functions described with reference to FIG. 1, 2, 3, 4, 5, or 6 related to wireless communication over the dedicated radio frequency spectrum band or the shared radio frequency spectrum band. For example, the UE wireless communication manager 750 may be configured to support a supplemental downlink mode (e.g., a licensed assisted access mode), a carrier aggregation mode, or a standalone mode using the dedicated radio frequency spectrum band or the shared radio frequency spectrum band. The UE wireless communication manager 750 may include a UE LTE/LTE-A component for dedicated RF spectrum band 755 configured to handle LTE/LTE-A communications in the dedicated radio frequency spectrum band, and a UE LTE/LTE-A component for shared RF spectrum band 760 configured to handle LTE/LTE-A communications in the shared radio frequency spectrum band. The UE wireless communication manager 750, or portions of it, may include a processor, or some or all of the functions of the UE wireless communication manager 750 may be performed by the UE processor 710 or in connection with the UE processor 710. In some examples, the UE wireless communication manager 750 may be an example of the wireless communication manager 520 described with reference to FIG. 5.

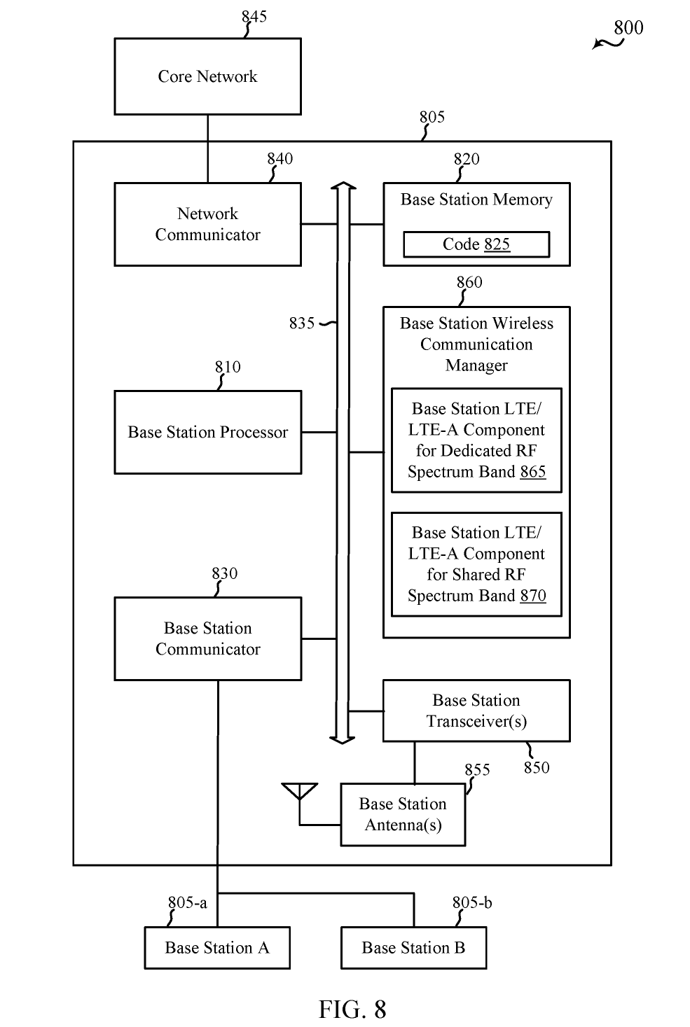

FIG. 8 shows a block diagram 800 of a base station 805 (e.g., a base station forming part or all of an eNB) for use in wireless communication, in accordance with various aspects of the present disclosure. In some examples, the base station 805 may be an example of one or more aspects of the base stations 105, 205, or 205-a described with reference to FIG. 1 or 2, or aspects of the apparatus 605 described with reference to FIG. 6. The base station 805 may be configured to implement or facilitate at least some of the base station techniques and functions described with reference to FIG. 1, 2, 3, 4, or 6.

The base station 805 may include a base station processor 810, a base station memory 820, at least one base station transceiver (represented by base station transceiver(s) 850), at least one base station antenna (represented by base station antenna(s) 855), or a base station wireless communication manager 860. The base station 805 may also include one or more of a base station communicator 830 or a network communicator 840. Each of these components may be in communication with each other, directly or indirectly, over one or more buses 835.

The base station memory 820 may include RAM or ROM. The base station memory 820 may store computer-readable, computer-executable code 825 containing instructions that are configured to, when executed, cause the base station processor 810 to perform various functions described herein related to wireless communication, including, for example, retransmitting at least one physical layer packet to a UE based at least in part on determining an SCC is inactive and determining at least one transmission on a physical channel is negatively acknowledged. Alternatively, the computer-executable code 825 may not be directly executable by the base station processor 810 but be configured to cause the base station 805 (e.g., when compiled and executed) to perform various of the functions described herein.

The base station processor 810 may include an intelligent hardware device, e.g., a CPU, a microcontroller, an ASIC, etc. The base station processor 810 may process information received through the base station transceiver(s) 850, the base station communicator 830, or the network communicator 840. The base station processor 810 may also process information to be sent to the transceiver(s) 850 for transmission through the antenna(s) 855, to the base station communicator 830, for transmission to one or more other base stations (e.g., base station 805-a and base station 805-b), or to the network communicator 840 for transmission to a core network 845, which may be an example of one or more aspects of the core network 130 described with reference to FIG. 1. The base station processor 810 may handle, alone or in connection with the base station wireless communication manager 860, various aspects of communicating over (or managing communications over) the dedicated radio frequency spectrum band or the shared radio frequency spectrum band. The dedicated radio frequency spectrum band may include a radio frequency spectrum band for which transmitting apparatuses may not contend for access (e.g., a radio frequency spectrum band licensed to users for various uses, such as a licensed radio frequency spectrum band usable for LTE/LTE-A communications). The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner).

The base station transceiver(s) 850 may include a modem configured to modulate packets and provide the modulated packets to the base station antenna(s) 855 for transmission, and to demodulate packets received from the base station antenna(s) 855. The base station transceiver(s) 850 may, in some examples, be implemented as one or more base station transmitters and one or more separate base station receivers. The base station transceiver(s) 850 may support communications in the dedicated radio frequency spectrum band or the shared radio frequency spectrum band. The base station transceiver(s) 850 may be configured to communicate bi-directionally, via the base station antenna(s) 855, with one or more UEs or apparatuses, such as one or more of the UEs 115, 215, 215-a, or 715 described with reference to FIG. 1, 2, or 7, or the apparatus 515 described with reference to FIG. 5. The base station 805 may, for example, include multiple base station antennas, such as multiple base station antenna(s) 855 (e.g., an antenna array). The base station 805 may communicate with the core network 845 through the network communicator 840. The base station 805 may also communicate with other base stations, such as the base station 805-a and the base station 805-b, using the base station communicator 830.

The base station wireless communication manager 860 may be configured to perform or control some or all of the techniques or functions described with reference to FIG. 1, 2, 3, 4, or 6 related to wireless communication over the dedicated radio frequency spectrum band or the shared radio frequency spectrum band. For example, the base station wireless communication manager 860 may be configured to support a supplemental DL mode (e.g., a licensed assisted access mode), a CA mode, or a standalone mode using the dedicated radio frequency spectrum band or the shared radio frequency spectrum band. The base station wireless communication manager 860 may include a base station LTE/LTE-A component for dedicated RF spectrum band 865 configured to handle LTE/LTE-A communications in the dedicated radio frequency spectrum band, and a base station LTE/LTE-A component for shared RF spectrum band 870 configured to handle LTE/LTE-A communications in the shared radio frequency spectrum band. The base station wireless communication manager 860, or portions of it, may include a processor, or some or all of the functions of the base station wireless communication manager 860 may be performed by the base station processor 810 or in connection with the base station processor 810. In some examples, the base station wireless communication manager 860 may be an example of the wireless communication manager 620 described with reference to FIG. 6.

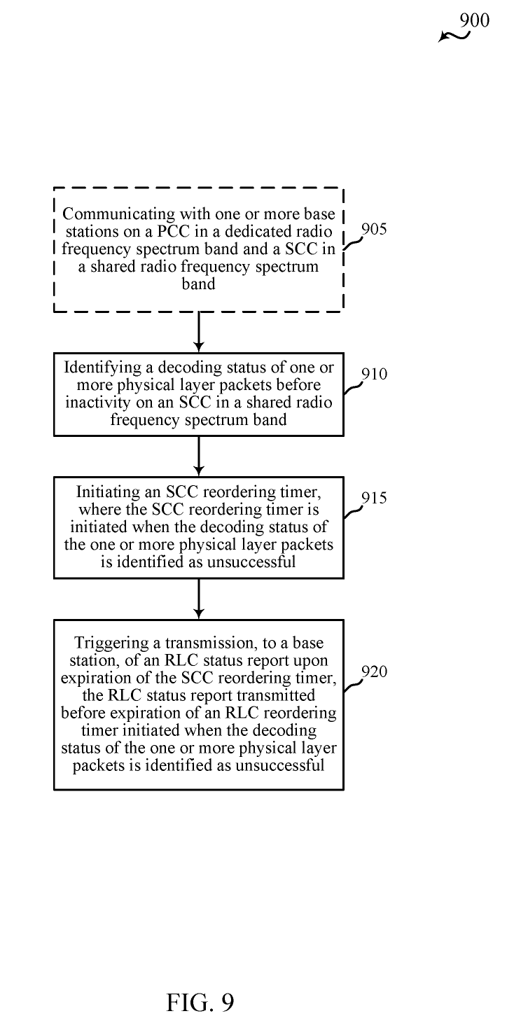

FIG. 9 is a flow chart illustrating an example of a method 900 for wireless communication at a UE, in accordance with various aspects of the present disclosure. For clarity, the method 900 is described below with reference to aspects of one or more of the UEs 115, 215, 215-a, 215-b, 215-c, or 715 described with reference to FIG. 1, 2, or 7, or aspects of the apparatus 515 described with reference to FIG. 5. In some examples, a UE may execute one or more sets of codes to control the functional elements of the UE to perform the functions described below. Additionally or alternatively, the UE may perform one or more of the functions described below using special-purpose hardware.

At block 905, the method 900 may optionally include communicating with one or more base stations on a PCC and an SCC. In some examples, communications on the PCC may be made in a dedicated radio frequency spectrum band, and communications on the SCC may be made in a shared radio frequency spectrum band. In other examples, communications on the PCC and the SCC may be made in the shared radio frequency spectrum band. The dedicated radio frequency spectrum band may include a radio frequency spectrum band for which transmitting apparatuses may not contend for access (e.g., a radio frequency spectrum band licensed to users for various uses, such as a licensed radio frequency spectrum band usable for LTE/LTE-A communications). The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner).

In some examples, the method 900 may include communicating with the one or more base stations on a PCC and multiple SCCs. Communication on at least one of the multiple SCCs may be in the shared radio frequency spectrum band, and communication on the other SCC(s) may be in the shared radio frequency spectrum band and/or the dedicated radio frequency spectrum band. The operation(s) at block 905 may be performed using the wireless communication manager 520 or UE wireless communication manager 750 described with reference to FIG. 5 or 7, or the component carrier manager 535 described with reference to FIG. 5.

At block 910, the method 900 may include identifying a decoding status of one or more physical layer packets before inactivity on an SCC in a shared radio frequency spectrum band. The operation(s) at block 910 may be performed using the wireless communication manager 520 or the UE wireless communication manager 750 described with reference to FIG. 5 or 7, or the physical layer decoding status identifier 550 described with reference to FIG. 5.

At block 915, the method 900 may include initiating an SCC reordering timer, where the SCC reordering timer is initiated when the decoding status of the one or more physical layer packets is identified as unsuccessful In some cases, the SCC reordering timer may have a predetermined duration, or may have a dynamically configured duration. The operation(s) at block 915 may be performed using the wireless communication manager 520 or UE wireless communication manager 750 described with reference to FIG. 5 or 7, or the SCC reordering timer manager 560 described with reference to FIG. 5.

At block 920, the method 900 may include triggering a transmission, to a base station, of a RLC status report. The RLC status report may be transmitted upon the expiration of the SCC reordering timer. In some cases, the RLC status report may be transmitted before expiration of a RLC reordering timer initiated when the decoding status of the one or more physical layer packets is identified as unsuccessful. In some examples, the triggering may be based at least in part on the unsuccessful decoding status being associated with the SCC (e.g., associated with physical layer packets scheduled for receipt on the SCC). The operation(s) at block 920 may be performed using the wireless communication manager 520 or UE wireless communication manager 750 described with reference to FIG. 5 or 7, or the RLC status reporter 555 described with reference to FIG. 5.

Thus, the method 900 may provide for wireless communication. It should be noted that the method 900 is just one possible implementation and that the operations of the method 900 may be rearranged or otherwise modified such that other implementations may also be possible.

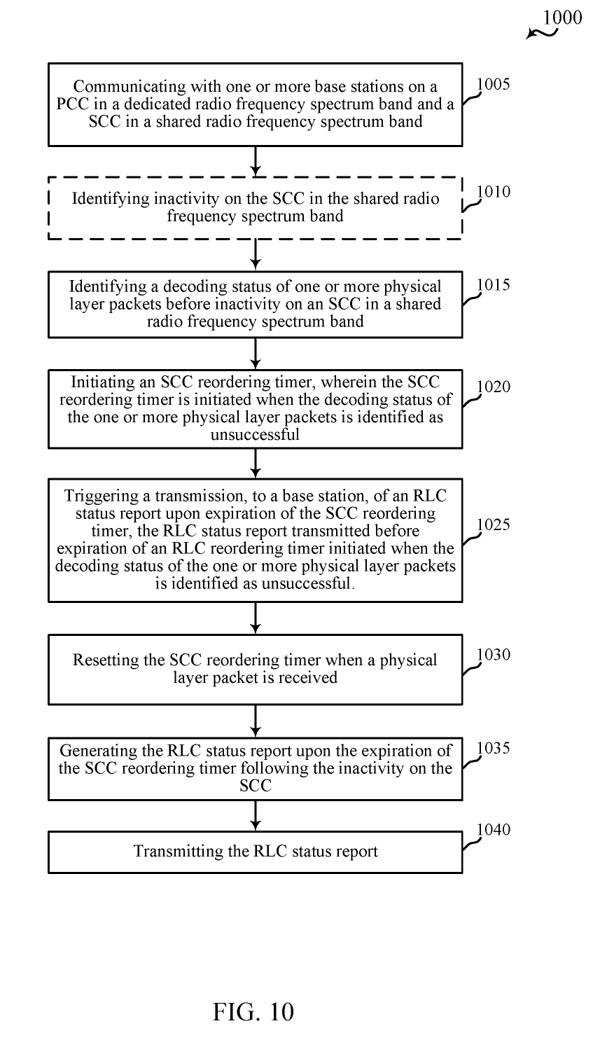

FIG. 10 is a flow chart illustrating an example of a method 1000 for wireless communication at a UE, in accordance with various aspects of the present disclosure. For clarity, the method 1000 is described below with reference to aspects of one or more of the UEs 115, 215, 215-a, 215-b, 215-c, or 715 described with reference to FIG. 1, 2, or 7, or aspects of the apparatus 515 described with reference to FIG. 5. In some examples, a UE may execute one or more sets of codes to control the functional elements of the UE to perform the functions described below. Additionally or alternatively, the UE may perform one or more of the functions described below using special-purpose hardware.

At block 1005, the method 1000 may include communicating with one or more base stations on a PCC and an SCC. In some examples, communications on the PCC may be made in a dedicated radio frequency spectrum band, and communications on the SCC may be made in a shared radio frequency spectrum band. In other examples, communications on the PCC and the SCC may be made in the shared radio frequency spectrum band. The dedicated radio frequency spectrum band may include a radio frequency spectrum band for which transmitting apparatuses may not contend for access (e.g., a radio frequency spectrum band licensed to users for various uses, such as a licensed radio frequency spectrum band usable for LTE/LTE-A communications). The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner).

In some examples, the method 1000 may include communicating with the one or more base stations on a PCC and multiple SCCs. Communication on at least one of the SCCs may be in the shared radio frequency spectrum band, and communication on the other SCC(s) may be in the shared radio frequency spectrum band and/or the dedicated radio frequency spectrum band. The operation(s) at block 1005 may be performed using the wireless communication manager 520 or UE wireless communication manager 750 described with reference to FIG. 5 or 7, or the component carrier manager 535 described with reference to FIG. 5.

At block 1010, the method 1000 may optionally include identifying inactivity on an SCC in the shared radio frequency spectrum band. Inactivity on the SCC may occur, for example, as a result of a base station with which the UE communicates (and/or the UE) losing contention for access to the shared radio frequency spectrum band. Communication between the UE and a base station on the PCC, and possibly on one or more other SCCs, may continue after inactivity on the SCC. The operation(s) at block 1010 may be performed using the wireless communication manager 520 or UE wireless communication manager 750 described with reference to FIG. 5 or 7, or the SCC inactivity detector 540 or 640 described with reference to FIG. 5.

At block 1015, the method 1000 may include identifying a decoding status of one or more physical layer packets before inactivity on an SCC in a shared radio frequency spectrum band. The operation(s) at block 1015 may be performed using the wireless communication manager 520 or UE wireless communication manager 750 described with reference to FIG. 5 or 7, or the physical layer decoding status identifier 550 described with reference to FIG. 5.

At block 1020, the method 1000 may include initiating an SCC reordering timer, where the SCC reordering timer is initiated when the decoding status of the one or more physical layer packets is identified as unsuccessful. The operation(s) at block 1020 may be performed using the wireless communication manager 520 or 620 or UE wireless communication manager 750 described with reference to FIG. 5, 6, or 7, or the SCC reordering timer manager 560 described with reference to FIG. 5.

At block 1025, the method 1000 may include triggering a transmission, to a base station, of an RLC status report. The transmission of the RLC status report may be triggered upon the expiration of the SCC reordering timer. Additionally, the RLC status report may be transmitted before expiration of an RLC reordering timer initiated when the decoding status of the one or more physical layer packets is identified as unsuccessful. In some examples, the triggering may be based at least in part on the unsuccessful decoding status being associated with the SCC (e.g., associated with physical layer packets scheduled for receipt on the SCC). The operation(s) at block 1025 may be performed using the wireless communication manager 520 or 620 or UE wireless communication manager 750 described with reference to FIG. 5, 6, or 7, or the RLC status reporter 555 described with reference to FIG. 5.

At block 1030, the method 1000 may include resetting the SCC reordering timer when a physical layer packet is received. The operation(s) at block 1030 may be performed using the wireless communication manager 520 or 620 or UE wireless communication manager 750 described with reference to FIG. 5, 6, or 7, or the SCC reordering timer manager 560 described with reference to FIG. 5.

At block 1035, the method 1000 may include generating the RLC status report upon the expiration of the SCC reordering timer following inactivity on the SCC. The operation(s) at block 1035 may be performed using the wireless communication manager 520 or 620 or UE wireless communication manager 750 described with reference to FIG. 5, 6, or 7, or the RLC status reporter 555 described with reference to FIG. 5.

At block 1040, the method 1000 may include transmitting the RLC status report. In some examples, the RLC status report may be transmitted on the PCC in the dedicated radio frequency spectrum band. In some examples, the RLC status report may be transmitted on a different SCC in the shared radio frequency spectrum band or in the dedicated radio frequency spectrum band. The operation(s) at block 1040 may be performed using the wireless communication manager 520 or 620 or UE wireless communication manager 750 described with reference to FIG. 5, 6, or 7, or the RLC status reporter 555 described with reference to FIG. 5.

Thus, the method 1000 may provide for wireless communication. It should be noted that the method 1000 is just one possible implementation and that the operations of the method 1000 may be rearranged or otherwise modified such that other implementations may also be possible.

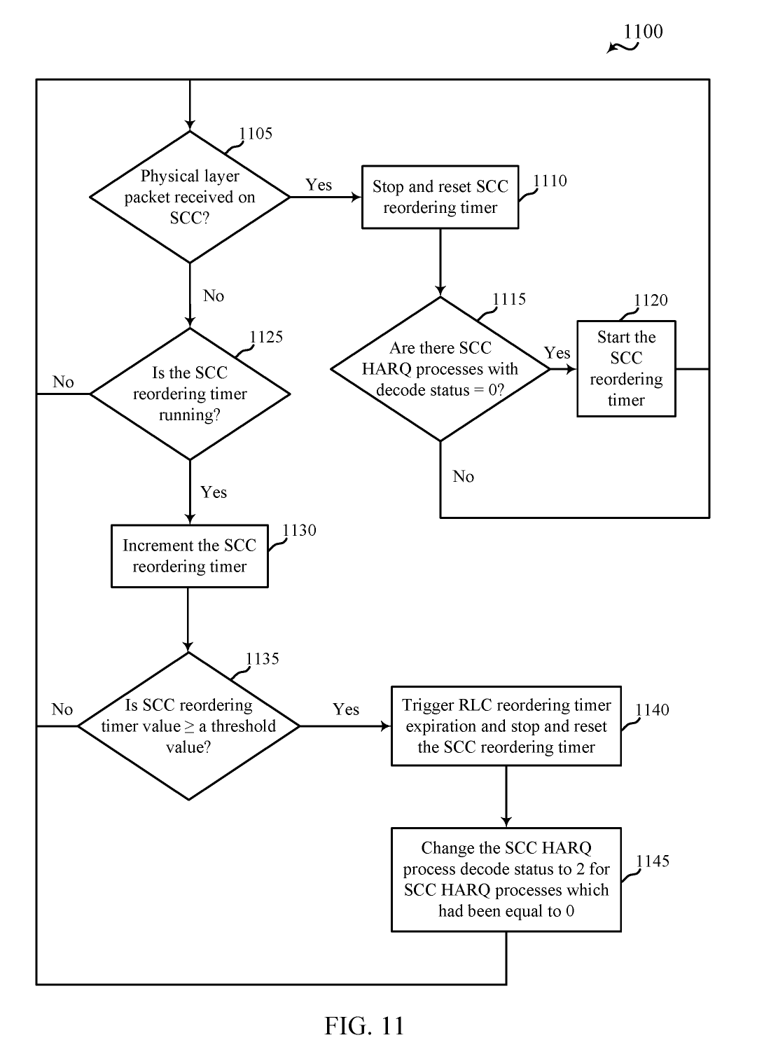

FIG. 11 is a flow chart illustrating an example of a method 1100 for wireless communication at a UE, in accordance with various aspects of the present disclosure. For clarity, the method 1000 is described below with reference to aspects of one or more of the UEs 115, 215, 215-a, 215-b, 215-c, or 715 described with reference to FIG. 1, 2, or 7, or aspects of the apparatus 515 described with reference to FIG. 5. In some examples, a UE may execute one or more sets of codes to control the functional elements of the UE to perform the functions described below. Additionally or alternatively, the UE may perform one or more of the functions described below using special-purpose hardware.

At block 1105, the method 1100 may include determining if a physical layer packet is received on an SCC. If the physical layer packet is received, then method 1100 may include stopping and resetting an SCC reordering timer at block 1110. At block 1115, after resetting the SCC reordering timer, the method 1100 may include determining whether an SCC HARQ processes includes a decode status 0. For example, a UE may refer to a table, such as Table 1 described with reference to FIG. 3, to determine if any HARQ processes have a decod status 0 associated with one or more TBs. If there are HARQ processes with a decode status 0, then the method 1100 may include starting the SCC reordering timer at block 1120. If it is determined that there are no SCC HARQ processes with decode status 0, the method 1100 may return to block 1105 for a next subframe, as there are no SCC HARQ processes that have failed.

Referring back to block 1105 of method 1100, if a physical layer packet is not received on the SCC, then at block 1125, the method 1100 may include determining if the SCC reordering timer is running. If the SCC reordering timer is not running, then the method 1100 may return to block 1105 to determine if physical layer packets are received on the SCC. Alternatively, if the SCC reordering timer is running, at block 1130 the timer may continue to increment (e.g., it may increment up to a predetermined duration, such as 24 ms).

At block 1135, the method 1100 may include determining if the SCC reordering timer satisfies a threshold value. For example, if there is a period of inactivity on the SCC and the SCC reordering timer is running, the SCC reordering timer may continue running up to a threshold value (e.g., 24 ms) and may subsequently expire. If the SCC reordering timer value does not satisfy the threshold value, then the method 1100 may return to block 1105 to monitor for the receipt of physical layer packets.

Upon expiration of the SCC reordering timer (i.e., the SCC reordering timer satisfies a threshold), at block 1140 the method 1100 may include triggering the expiration of an RLC reordering timer, and the SCC reordering timer is stopped and reset. At block 1145, the method 1100 may further include changing the decode status for SCC HARQ processes. For instance, SCC HARQ processes that reflect a decode status 0 may be changed to decode status 2, which may enable a “fake pass” for any previously failed SCC HARQ processes.

Thus, the method 1100 may provide for wireless communication. It should be noted that the method 1100 is just one possible implementation and that the operations of the method 1100 may be rearranged or otherwise modified such that other implementations may also be possible.

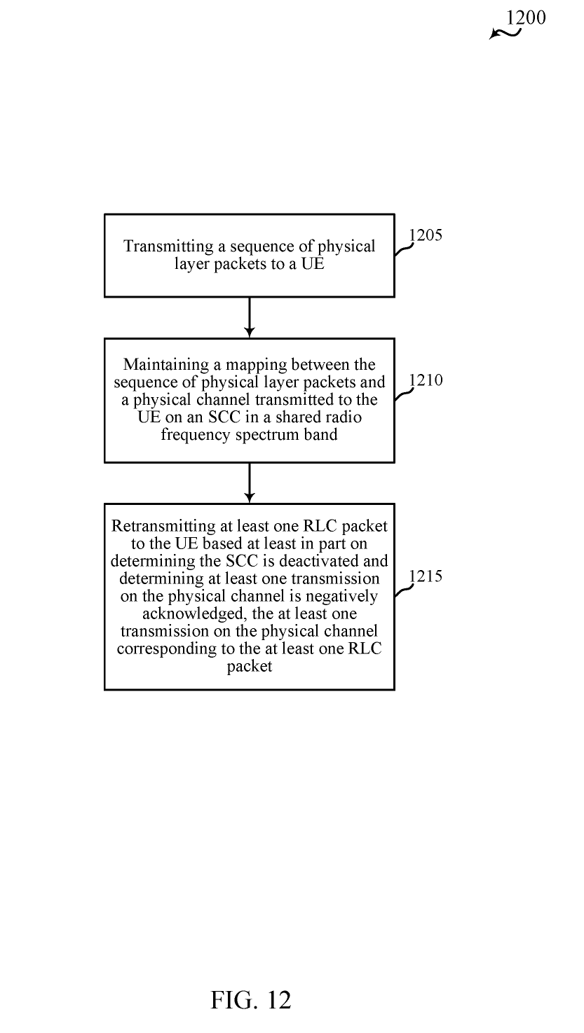

FIG. 12 is a flow chart illustrating an example of a method 1200 for wireless communication at a base station, in accordance with various aspects of the present disclosure. For clarity, the method 1200 is described below with reference to aspects of one or more of the base stations 105, 205, 205-a, or 805 described with reference to FIG. 1, 2, or 8, or aspects of the apparatus 605 described with reference to FIG. 6. In some examples, a base station may execute one or more sets of codes to control the functional elements of the base station to perform the functions described below. Additionally or alternatively, the base station may perform one or more of the functions described below using special-purpose hardware.

At block 1205, the method 1200 may include transmitting a sequence of physical layer packets to a UE. The operation(s) at block 1205 may be performed using the wireless communication manager 620 or base station wireless communication manager 860 described with reference to FIG. 6 or 8, or the RLC transmission manager 635 described with reference to FIG. 6.

At block 1210, the method 1200 may include maintaining a mapping between the sequence of physical layer packets and a physical channel transmitted to the UE on an SCC in a shared radio frequency spectrum band. The shared radio frequency spectrum band may include a radio frequency spectrum band for which transmitting apparatuses may contend for access (e.g., a radio frequency spectrum band that is available for unlicensed use, such as Wi-Fi use, a radio frequency spectrum band that is available for use by different radio access technologies, or a radio frequency spectrum band that is available for use by multiple operators in an equally shared or prioritized manner). The operation(s) at block 1210 may be performed using the wireless communication manager 620 or base station wireless communication manager 860 described with reference to FIG. 6 or 8, or the physical layer packet mapper 640 described with reference to FIG. 6.

At block 1215, the method 1200 may include retransmitting at least one physical layer packet to the UE based at least in part on determining the SCC is inactive and determining at least one transmission on the physical channel is negatively acknowledged. The at least one transmission on the physical channel may correspond to the at least one physical layer packet. In some examples, the retransmitting may occur on a PCC in a dedicated radio frequency spectrum band. The dedicated radio frequency spectrum band may include a radio frequency spectrum band for which transmitting apparatuses may not contend for access (e.g., a radio frequency spectrum band licensed to users for various uses, such as a licensed radio frequency spectrum band usable for LTE/LTE-A communications). The operation(s) at block 1215 may be performed using the wireless communication manager 620 or base station wireless communication manager 860 described with reference to FIG. 6 or 8, or the packet retransmission manager 645 described with reference to FIG. 6.

Thus, the method 1200 may provide for wireless communication. It should be noted that the method 1200 is just one possible implementation and that the operations of the method 1200 may be rearranged or otherwise modified such that other implementations may also be possible.

In some examples, aspects from two or more of the methods 900, 1000, 1100, or 1200 described with reference to FIG. 9, 10, 11, or 12 may be combined. It should be noted that the methods 900, 1000, 1100, or 1200 are just example implementations, and that the operations of the methods 900, 1000, 1100, or 1200 may be rearranged or otherwise modified such that other implementations are possible.

Techniques described herein may be used for various wireless communications systems such as code division multiple access (CDMA), time division multiple access (TDMA), FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A may be referred to as CDMA2000 1×, 1×, etc. IS-856 (TIA-856) may be referred to as CDMA2000 1×EV-DO, high rate packet data (HRPD), etc. UTRA includes wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-A are new releases of UMTS that use E-UTRA. UTRA, E-UTRA, UMTS, LTE, LTE-A, and GSM are described in documents from an organization named 3GPP. CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C, as well as any combination with multiples of the same element (e.g., A-A, A-A-A, A-A-B, A-A-C, A-B-B, A-C-C, B-B, B-B-B, B-B-C, C-C, and C-C-C or any other ordering of A, B, and C).

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel techniques disclosed herein.

What is claimed is:

1. A method for wireless communication at a user equipment (UE), comprising:
identifying a decoding status of one or more physical layer packets before inactivity on a secondary component carrier (SCC) in a shared radio frequency spectrum band;
initiating an SCC reordering timer, the SCC reordering timer initiated when the decoding status of the one or more physical layer packets is identified as unsuccessful; and
triggering a transmission, to a base station, of a radio link control (RLC) status report upon expiration of the SCC reordering timer, the RLC status report transmitted before expiration of an RLC reordering timer initiated when the decoding status of the one or more physical layer packets is identified as unsuccessful.

2. The method of claim 1, wherein the unsuccessful decoding status is associated with the SCC.

3. The method of claim 1, further comprising:
resetting the SCC reordering timer when a physical layer packet is received.

4. The method of claim 1, further comprising:
generating the RLC status report upon the expiration of the SCC reordering timer following the inactivity on the SCC.

5. The method of claim 1, wherein the SCC reordering timer comprises a predefined duration or a dynamically configured duration.

6. The method of claim 1, further comprising:
communicating with the base station on a primary component carrier (PCC) in a dedicated radio frequency spectrum band before and after the inactivity on the SCC.

7. The method of claim 1, further comprising:
stopping and resetting the RLC reordering timer based at least in part on triggering the transmission of the RLC status report.

8. The method of claim 1, wherein the RLC status report comprises a status for physical layer packets associated with sequence numbers preceding a sequence number of a first physical layer packet received after the inactivity on the SCC.

9. An apparatus for wireless communication at a user equipment (UE), comprising:
a processor;
memory in electronic communication with the processor; and
the processor and memory configured to:
identify a decoding status of one or more physical layer packets before inactivity on a secondary component carrier (SCC) in a shared radio frequency spectrum band;
initiate an SCC reordering timer, wherein the SCC reordering timer is initiated when the decoding status of the one or more physical layer packets is identified as unsuccessful; and
trigger a transmission, to a base station, of a radio link control (RLC) status report upon expiration of the SCC reordering timer, the RLC status report transmitted before expiration of an RLC reordering timer initiated when the decoding status of the one or more physical layer packets is identified as unsuccessful.

10. The apparatus of claim 9, wherein the unsuccessful decoding status is associated with the SCC.

11. The apparatus of claim 9, wherein the instructions are executable by the processor to:
reset the SCC reordering timer when a physical layer packet is received.

12. The apparatus of claim 9, wherein the instructions are executable by the processor to:
generate the RLC status report upon the expiration of the SCC reordering timer following the inactivity on the SCC.

13. The apparatus of claim 9, wherein the SCC reordering timer comprises a predefined duration or a dynamically configured duration.

14. The apparatus of claim 9, wherein the instructions are executable by the processor to:
communicate with the base station on a primary component carrier (PCC) in a dedicated radio frequency spectrum band before and after the inactivity on the SCC.

15. The apparatus of claim 9, wherein the instructions are executable by the processor to:
stop and reset the RLC reordering timer based at least in part on triggering the transmission of the RLC status report.

16. The apparatus of claim 9, wherein the RLC status report comprises a status for physical layer packets associated with sequence numbers preceding a sequence number of a first physical layer packet received after the inactivity on the SCC.

17. A method for wireless communication at a base station, comprising:
transmitting a sequence of physical layer packets to a user equipment (UE);
maintaining a mapping between the sequence of physical layer packets and a physical channel transmitted to the UE on a secondary component carrier (SCC) in a shared radio frequency spectrum band; and
retransmitting at least one physical layer packet to the UE based at least in part on determining the SCC is inactive and determining at least one transmission on the physical channel is negatively acknowledged, the at least one transmission on the physical channel corresponding to the at least one physical layer packet.

18. The method of claim 17, wherein the retransmitting of the at least one physical layer packet occurs on a primary component carrier (PCC) in a dedicated radio frequency spectrum band.

19. An apparatus for wireless communication at a base station, comprising:
a processor;
memory in electronic communication with the processor; and
the processor and memory configured to:
transmit a sequence of physical layer packets to a user equipment (UE);
maintain a mapping between the sequence of physical layer packets and a physical channel transmitted to the UE on a secondary component carrier (SCC) in a shared radio frequency spectrum band; and
retransmit at least one physical layer packet to the UE based at least in part on determining the SCC is inactive and determining at least one transmission on the physical channel is negatively acknowledged, the at least one transmission on the physical channel corresponding to the at least one physical layer packet.

20. The apparatus of claim 19, wherein the retransmitting of the at least one physical layer packet occurs on a primary component carrier (PCC) in a dedicated radio frequency spectrum band.
